(19) United States
(12) Patent Application Publication
(10) Pub. No.: US 2025/0199522 A1
(43) Pub. Date: Jun. 19, 2025

(54) DIAGNOSIS DEVICE AND COMPUTER-READABLE RECORDING MEDIUM

(71) Applicant: FANUC CORPORATION, Yamanashi (JP)

(72) Inventors: Kazuhiro SATOU, Yamanashi (JP); Motoki SATO, Yamanashi (JP)

(21) Appl. No.: 18/718,800

(22) PCT Filed: Jan. 24, 2022
(86) PCT No.: PCT/JP2022/002437

§ 371 Date: Dec. 9, 2024

(51) Int. Cl. G05B 23/02

(52) U.S. Cl. CPC G05B 23/027

(57) ABSTRACT

The diagnosis device according to the present disclosure comprises: a data acquisition unit that acquires data indicating a predetermined state pertaining to industrial machine; a diagnosis unit that calculates an abnormality degree of the state on the basis of a separation degree of the data acquired by the data acquisition unit from a distribution of the data acquired in a reference state; a change degree calculation unit that calculates a degree of change in abnormality as a change degree; a first alert generation unit that compares the abnormality degree to an abnormality degree threshold value and determines whether or not a predetermined notification is required; a second alert generation unit that compares the change degree to a change degree threshold value and determines whether or not the predetermined notification is required; and a notification unit that outputs the predetermined notification on the basis of the results of the determinations by the first alert generation unit and the second alert generation unit.

### TECHNICAL FIELD

The present invention relates to a diagnostic device and a computer-readable recording medium.

### BACKGROUND ART

At manufacturing sites such as factories, diagnosis of an operating state of an industrial machine such as a machine tool or a robot, diagnosis of a non-defective product/defective product in products, etc. have been performed. Work requiring such diagnosis has conventionally been performed by an experienced worker visually or while referring to a value detected by a sensor. However, in manual work, there are problems in that accuracy of diagnosis varies due to a difference in criteria based on a difference in experience of each worker, a lack of concentration due to changes in physical condition, etc. For this reason, many manufacturing sites introduce devices that perform automatic diagnosis based on data detected by sensors, etc. for various diagnostic tasks.

For example, a device that diagnoses the operating state of the industrial machine calculates an abnormality degree based on a deviation degree from a value (sensor data, etc.) representing a state of the machine at normal times. Then, the calculated abnormality degree is presented to a user. In this method, the user needs to monitor changes in a value of the abnormality degree. Therefore, it is desirable to automatically issue a warning based on the value of the calculated abnormality degree. For example, a commonly used method is to set a threshold for the abnormality degree and notify the user of occurrence of an abnormality when the abnormality degree exceeds the threshold (Patent Document 1, etc.).

### CITATION LIST

### Patent Document

Patent Document 1: JP 2020-006459 A

### SUMMARY OF THE INVENTION

### Problem to be Solved by the Invention

When a state is diagnosed using a threshold, if the abnormality degree drifts due to environmental changes, it becomes impossible to appropriately diagnose the state. To deal with such a situation, it is necessary to provide a margin to a certain extent for the threshold of the abnormality degree according to an environment. Therefore, sensitivity for detecting an abnormality may be low if only a simple comparison with the threshold is used.

Furthermore, interpretation of the abnormality degree may differ between an abnormality mode in which the abnormality degree gradually changes (such as wear mode) and an abnormality mode in which the abnormality degree abruptly changes (such as tool breakage mode). In this way, only the simple comparison with the threshold may be insufficient as a diagnostic method.

Therefore, there is need for state detection technology that takes into consideration not only changes that abruptly occur but also changes that gradually progress.

### Means for Solving Problem

A diagnostic device according to the invention solves the above problem by detecting an abnormality while considering a change degree in the abnormality degree in addition to the abnormality degree.

Further, an aspect of the present disclosure is a diagnostic device configured to diagnose a predetermined state related to an industrial machine, and the diagnostic device includes a data acquisition unit configured to acquire data indicating a predetermined state related to the industrial machine, a diagnostic unit configured to calculate an abnormality degree of the state for the data acquired by the data acquisition unit based on a deviation degree from a distribution of the data acquired in a reference state, a change rate calculation unit configured to calculate a change degree of the abnormality degree as a change rate, a first alert generation unit configured to compare the abnormality degree with an abnormality degree threshold and determine whether or not a predetermined notification is necessary, a second alert generation unit configured to compare the change rate with a change rate threshold and determine whether or not the predetermined notification is necessary, and a notification unit configured to output the predetermined notification based on results of determinations by the first alert generation unit and the second alert generation unit.

Another aspect of the disclosure is a computer-readable recording medium recording a program causing a computer to execute processing for diagnosing a predetermined state related to an industrial machine, the computer-readable recording medium recording the program causing the computer to operate as a data acquisition unit configured to acquire data indicating a predetermined state related to the industrial machine, a diagnostic unit configured to calculate an abnormality degree of the state for the data acquired by the data acquisition unit based on a deviation degree from a distribution of the data acquired in a reference state, a change rate calculation unit configured to calculate a change degree of the abnormality degree as a change rate, a first alert generation unit configured to compare the abnormality degree with an abnormality degree threshold and determine whether or not a predetermined notification is necessary, a second alert generation unit configured to compare the change rate with a change rate threshold and determine whether or not the predetermined notification is necessary, and a notification unit configured to output the predetermined notification based on results of determinations by the first alert generation unit and the second alert generation unit.

### Effect of the Invention

According to one aspect of the disclosure, it is possible to flexibly detect an abnormality for each of an abnormality mode in which an abnormality degree gradually changes and an abnormality mode in which the abnormality degree abruptly changes.

### BRIEF DESCRIPTION OF DRAWINGS

FIG. 1 is a schematic hardware configuration diagram of a diagnostic device according to an embodiment of the invention;

FIG. 2 is a block diagram schematically illustrating functions of the diagnostic device according to a first embodiment of the invention;

FIG. 3 is a diagram illustrating an example of an abnormality degree threshold table;

FIG. 4 is a diagram illustrating an example of a change rate threshold table;

FIG. 5 is a graph illustrating a temporal change in an abnormality degree related to a torque command of a spindle motor;

FIG. 6 is a graph illustrating a temporal change in an abnormality degree related to a torque command of a feed axis motor;

FIG. 7 is a block diagram illustrating schematic functions of a diagnostic device according to a second embodiment;

FIG. 8 is a block diagram illustrating schematic functions of a diagnostic device according to a modification of the second embodiment;

FIG. 9 is a diagram illustrating an example of a threshold setting screen;

FIG. 10 is a block diagram illustrating schematic functions of a diagnostic device according to another embodiment of the invention; and

FIG. 11 is a diagram illustrating an example of a conditional expression table.

### MODE(S) FOR CARRYING OUT THE INVENTION

Embodiments of the invention will be described below with reference to the drawings.

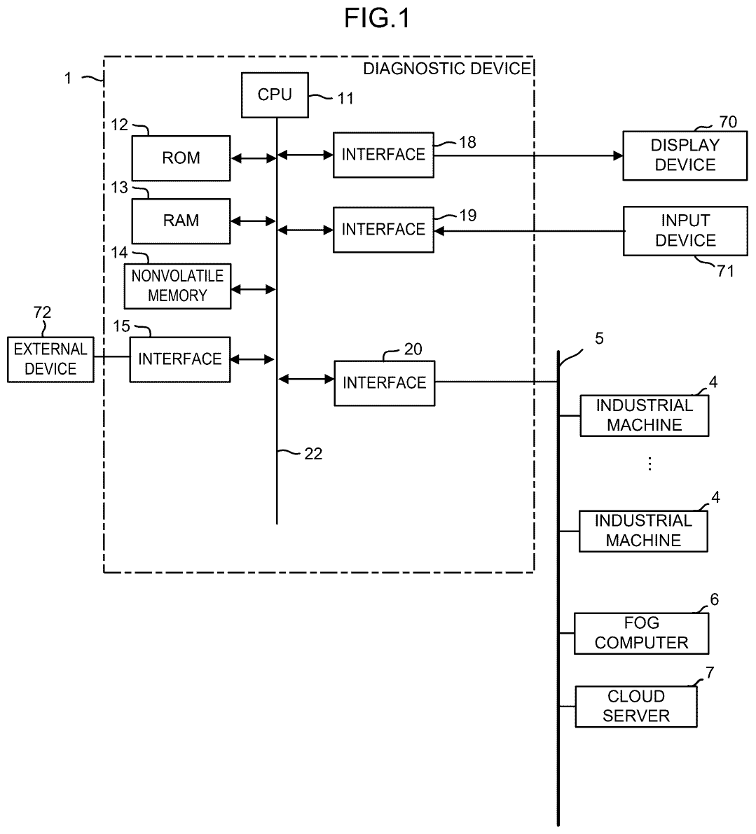

FIG. 1 is a schematic hardware configuration diagram illustrating a main part of a diagnostic device according to an embodiment of the invention. For example, the diagnostic device 1 of the invention can be amounted as a controller that controls an industrial machine 4 based on a control program. Further, the diagnostic device 1 of the invention can be mounted on a personal computer installed side by side with a controller that controls the industrial machine 4 based on a control program, a personal computer connected to the controller via a wired/wireless network, a cell computer, a fog computer 6, or a cloud server 7. This embodiment illustrates an example in which the diagnostic device 1 is mounted on the personal computer connected to the controller of the industrial machine 4 via the network.

A CPU 11 included in the diagnostic device 1 of the invention is a processor that controls the entire diagnostic device 1. The CPU 11 reads a system program stored in a ROM 12 via a bus 22, and controls the entire diagnostic device 1 in accordance with the system program. A RAM 13 temporarily stores temporary calculation data, display data, various data input from the outside, etc.

For example, a nonvolatile memory 14 includes a memory backed up by a battery (not illustrated), a solid state drive (SSD), etc., and a storage state is maintained even when power of the diagnostic device 1 is turned off. The nonvolatile memory 14 stores data and programs read from an external device 72 via an interface 15, data and programs input via an input device 71, data acquired from the industrial machine 4, etc. The data and programs stored in the nonvolatile memory 14 may be loaded in the RAM 13 during execution/use. Further, various system programs such as known analysis programs are written to the ROM 12 in advance.

The interface 15 is an interface for connecting the CPU 11 of the diagnostic device 1 to the external device 72 such as a USB device. For example, programs related to the functions of the diagnostic device 1, various data related to service provision, etc. can be read from the external device 72 side. Furthermore, programs and various data edited in the diagnostic device 1 can be stored in external storage means via the external device 72.

Each piece of data read to the memory, and data obtained as a result of executing a program, a system program, etc. are output to and displayed on a display device 70 via an interface 18. Further, the input device 71 including a keyboard, a pointing device, etc. passes commands, data, etc. based on operations by the worker to the CPU 11 via an interface 19.

An interface 20 is an interface for connecting the CPU 11 of the diagnostic device 1 and the network 5 to each other. The network 5 may be a WAN (Wide Area Network) including an exclusive line, etc., or may be a wide area network such as the Internet. The industrial machine 4 such as a machine tool or a robot installed in factories, etc., the fog computer 6, the cloud server 7, etc. are connected to the network 5. Each of these devices exchanges data with the diagnostic device 1 via the network 5.

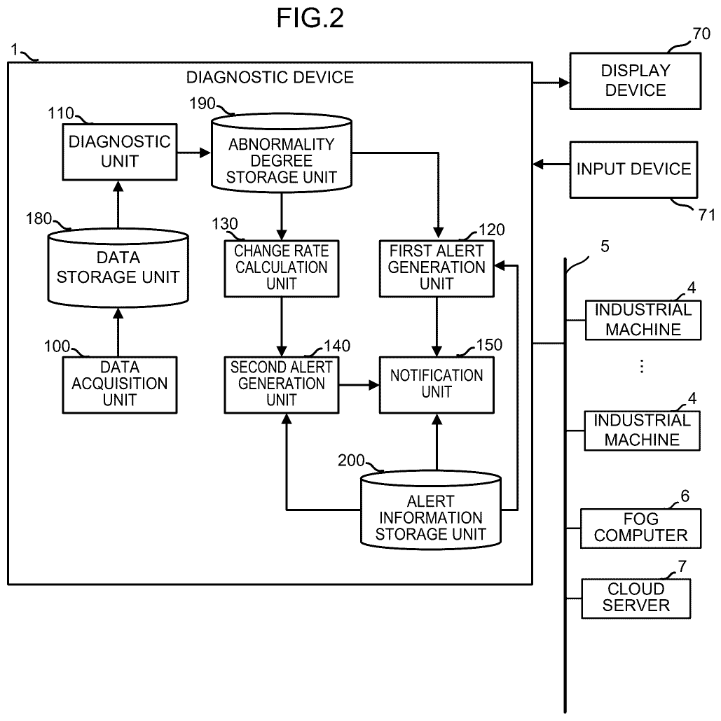

FIG. 2 illustrates functions of the diagnostic device 1 according to a first embodiment of the invention as a schematic block diagram. Each function of the diagnostic device 1 according to this embodiment is realized by the CPU 11 of the diagnostic device 1 illustrated in FIG. 1 executing a system program and controlling an operation of each unit of the diagnostic device 1.

The diagnostic device 1 of this embodiment includes a data acquisition unit 100, a diagnostic unit 110, a first alert generation unit 120, a change rate calculation unit 130, a second alert generation unit 140, and a notification unit 150. Further, a data storage unit 180, which is an area for storing data acquired by the data acquisition unit 100, an abnormality degree storage unit 190, which is an area for storing an abnormality degree calculated by the diagnostic unit 110, and an alert information storage unit 200, which is an area storing information related to alert in advance, are prepared in advance in the RAM 13 or the nonvolatile memory 14 of the diagnostic device 1.

The data acquisition unit 100 acquires data indicating a predetermined state related to the industrial machine 4 and stores the data in the data storage unit 180. The data acquired by the data acquisition unit 100 may be, for example, a sensor signal detected by a sensor, etc. during operation of the industrial machine 4. For example, the sensor signal may be a current value, a voltage value, a position, a speed, and acceleration related to driving of a motor attached to the industrial machine 4, a temperature detected by a temperature sensor, humidity detected by a humidity sensor, vibration detected by a vibration sensor, pressure detected by a pressure sensor, sound detected by a sound sensor, light detected by an optical sensor, video detected by a visual sensor, etc. The data acquired by the data acquisition unit 100 may be data indicating an operating state of the industrial machine 4 or inspection data acquired by inspecting a product manufactured by the industrial machine 4. Further, the data may be other data indicating a state of an environment at a manufacturing site where the industrial machine 4 is installed.

The data acquisition unit 100 may acquire data from the industrial machine 4, the fog computer 6, the cloud server 7, etc. via the wired or wireless network 5. Further, data stored in a memory such as CompactFlash (registered trademark) may be acquired via the external device 72. Furthermore, the worker may manually input data from the input device 71.

The diagnostic unit 110 calculates an abnormality degree of data acquired by the data acquisition unit 100. For example, the diagnostic unit 110 stores at least one piece of reference data in a predetermined reference state. Then, a deviation degree indicating a degree of deviation from a distribution of the reference data may be calculated as the abnormality degree. As a method for calculating the deviation degree, for example, the deviation degree may be simply calculated based on a degree of deviation of a distribution of acquired data from the distribution of the reference data. In addition, the distribution of the reference data may be regarded as a cluster, and a deviation degree from the cluster may be calculated using a known method such as the k-means method. Then, the diagnostic unit 110 may calculate the abnormality degree so that a larger value is obtained as the deviation degree increases. The diagnostic unit 110 stores the calculated abnormality degree in the abnormality degree storage unit 190 together with a time when data serving as a basis of calculation of the abnormality degree is detected.

The first alert generation unit 120 determines whether or not a predetermined notification is necessary based on an abnormality degree related to predetermined data calculated by the diagnostic unit 110. For example, the first alert generation unit 120 may compare the abnormality degree calculated by the diagnostic unit 110 with a predetermined abnormality degree threshold, and determine that the predetermined notification is necessary when the abnormality degree threshold is exceeded. The predetermined notification may be, for example, a warning notification related to the predetermined data. Note that the abnormality degree calculated from the data may be directly used. However, in such a case, a result of determination may be inaccurate due to noise generated in the data. To avoid such a case, a predetermined statistic (for example, mean, median, 95th percentile, etc.) may be calculated based on a plurality of abnormality degrees calculated over a certain time interval to treat the statistic as the abnormality degree at that timing.

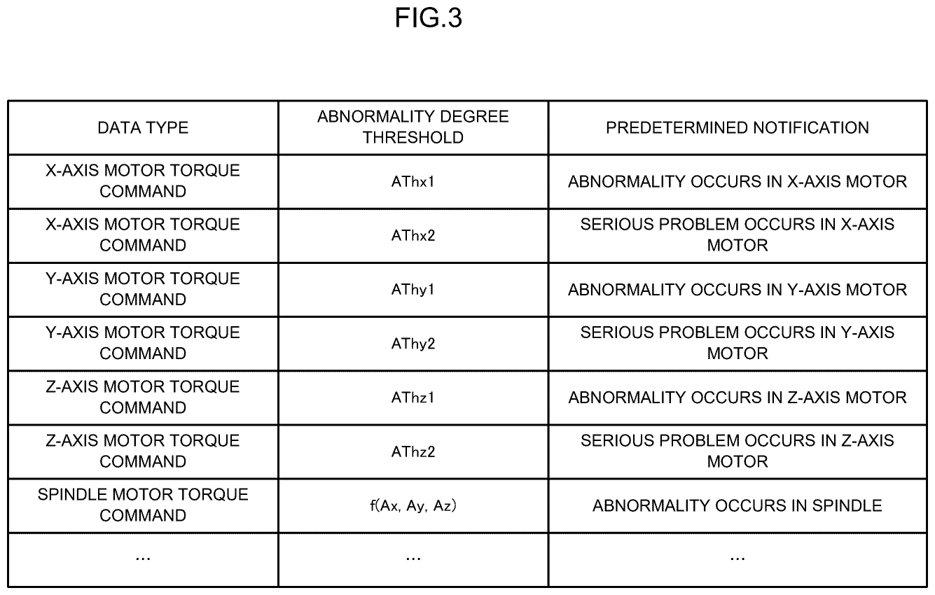

The abnormality degree threshold may be determined in advance for each type of data. Further, a plurality of abnormality degree thresholds may be associated with one data type. Furthermore, the threshold may be dynamically changed based on a predetermined data value or abnormality degree. For example, a relationship between the data type and the abnormality degree threshold may be stored in association with each other in the alert information storage unit 200 in advance. FIG. 3 illustrates an example in which the relationship between the data type and the abnormality degree threshold is determined using an abnormality degree threshold table. As illustrated in FIG. 3, the abnormality degree threshold table stores at least one or more pieces of abnormality degree threshold data that associate an abnormality degree threshold with a predetermined notification for each data type. In the example of FIG. 3, for example, for torque command data of an X-axis motor, two abnormality degree thresholds, AThx1 and AThx2, are defined, and notifications “an abnormality occurs in the X-axis motor” and “a serious problem occurs in the X-axis motor” are associated therewith, respectively. In addition, for torque command data of a spindle motor, a function f for calculating the abnormality degree threshold using an abnormality degree Ax of a torque command of the X-axis motor, an abnormality degree Ay of a torque command of a Y-axis motor, and an abnormality degree Az of a torque command of a Z-axis motor as arguments is defined, and a notification “an abnormality occurs in the spindle” is associated therewith. The first alert generation unit 120 specifies the abnormality degree threshold according to each type of data with reference to this table. Then, necessity of a predetermined notification is determined by comparing an abnormality degree of each piece of data with the specified abnormality degree threshold.

The change rate calculation unit 130 calculates a change rate indicating a change degree of the abnormality degree calculated by the diagnostic unit 110. For example, the change rate calculation unit 130 may calculate the change rate based on a difference between values of the abnormality degree calculated by the diagnostic unit 110 and an abnormality degree calculated by the diagnostic unit 110 previously (for example, before one time). Further, for example, the change rate may be calculated based on a predetermined statistic calculated from abnormality degrees of the most recent n times calculated by the diagnostic unit 110. Furthermore, for example, a change rate D may be calculated using the following Equation 1. Note that, in Equation 1, A denotes an abnormality degree for which the change rate is calculated, p denotes an average value of abnormality degrees of the most recent m times (m is an integer, for example, 50), and 6 denotes a standard deviation of the abnormality degrees of the most recent m times.

$$D = \frac{\vert A - μ \vert}{σ} \qquad [ Equation 1 ]$$

The change rate calculated by the change rate calculation unit 130 is an index indicating how much an abnormality degree calculated from data acquired at the timing of calculating the change rate as illustrated above changes compared to an abnormality degree calculated therebefore. As long as the change rate can be treated as such an index, the change rate may be calculated using a calculation method other than the above method. Note that, when the change rate is calculated, calculation may be performed directly using the abnormality degree calculated from the data. However, in such a case, a large change rate may be abruptly calculated due to noise occurring in the data. To avoid such a case, a predetermined statistic (for example, mean, median, nth percentile, for example, 95th percentile, etc.) may be calculated based on a plurality of abnormality degrees calculated over a certain time interval, and the change rate may be calculated by treating the statistic as an abnormality degree at that timing.

The second alert generation unit 140 determines whether or not a predetermined notification is necessary based on the change rate of the abnormality degree related to predetermined data calculated by the change rate calculation unit 130. For example, the second alert generation unit 140 may compare the change rate calculated by the change rate calculation unit 130 with a predetermined change rate threshold, and determine that the predetermined notification is necessary when the change rate threshold is exceeded. The predetermined notification may be, for example, a warning notification related to the predetermined data. The change rate threshold may be determined in advance for each type of data, or may be dynamically changed based on a predetermined condition.

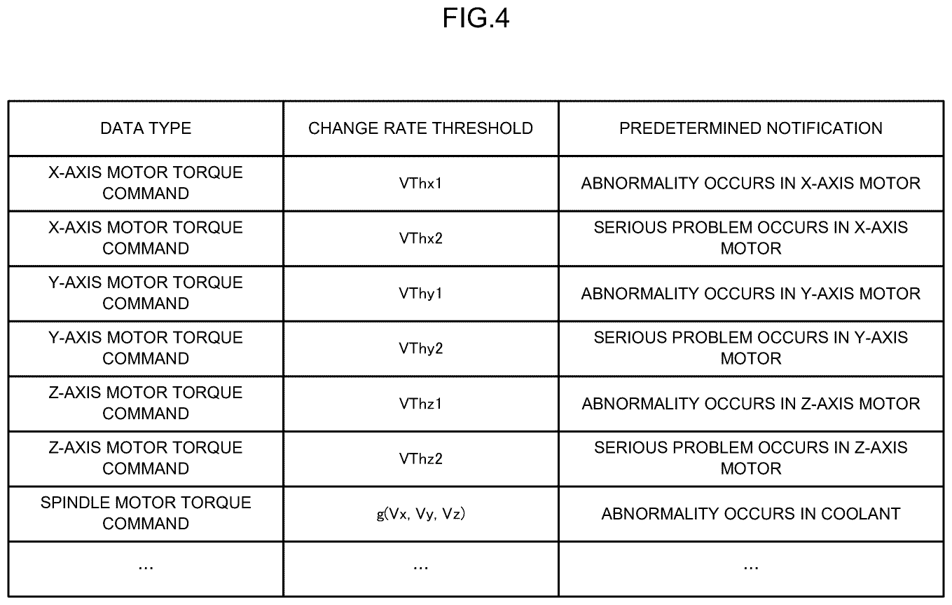

The change rate threshold may be determined in advance for each type of data. Furthermore, a plurality of change rate thresholds may be associated with one data type. Furthermore, the threshold may dynamically change based on a value of predetermined data or a change rate. For example, a relationship between the data type and the change rate threshold may be stored in advance in the alert information storage unit 200 in association with each other. FIG. 4 illustrates an example in which the relationship between the data type and the change rate threshold is determined using a change rate threshold table. As illustrated in FIG. 4, the change rate threshold table stores at least one or more pieces of change rate threshold data that associate a change rate threshold with a predetermined notification for each type of data. In the example of FIG. 4, for example, for a change rate of an abnormality degree of torque command data of the X-axis motor, two change rate thresholds, VThx1 and VThx2, are defined, and notifications “an abnormality occurs in the X-axis motor” and “a serious problem occurs in the X-axis motor” are associated therewith, respectively. In addition, for torque command data of the spindle motor, a function g for calculating the abnormality degree threshold using a change rate Vx of an abnormality degree of a torque command of the X-axis motor, a change rate Vy of an abnormality degree of a torque command of the Y-axis motor, and a change rate Vz of an abnormality degree of a torque command of the Z-axis motor as arguments is defined, and a notification “an abnormality occurs in a coolant” is associated therewith. The second alert generation unit 140 specifies the change rate threshold according to each type of data with reference to this table. Then, necessity of a predetermined notification is determined by comparing a change rate of an abnormality degree of each piece of data with the specified change rate threshold.

The notification unit 150 determines whether or not a predetermined notification is necessary based on results of determinations made by the first alert generation unit 120 and the second alert generation unit 140. Then, the predetermined notification is output based on the determination results. For example, the notification unit 150 may determine content of the predetermined notification with reference to abnormality degree threshold data or change rate threshold data stored in the alert information storage unit 200. A notification destination of the predetermined notification by the notification unit 150 may be, for example, display of a message on the display device 70. Furthermore, the message may be transmitted via the network 5 to the industrial machine 4 detecting an abnormality, the higher-level fog computer 6, or the cloud server 7. Furthermore, information indicating that the notification has been issued may be recorded in a log storage area (not illustrated) of the diagnostic device 1. In this instance, the notification unit 150 may be configured to receive information indicating whether or not the user has confirmed the notification, record the information in a log, and manage the information. When such a configuration is adopted, the notification unit 150 may periodically re-issue notifications that have not been confirmed by the user.

The notification unit 150 may also notify a current time, a value of data causing the notification of the abnormality, an abnormality degree calculated from the data, a change rate of the abnormality degree, etc., with respect to the notification content. Further, various information related to the most recent change in the data causing the abnormality or the abnormality degree, and other data acquired at the same timing may also be notified.

Hereinafter, a description will be given of an example of diagnostic processing of an operational status of the industrial machine 4 by the diagnostic device 1 having the above configuration.

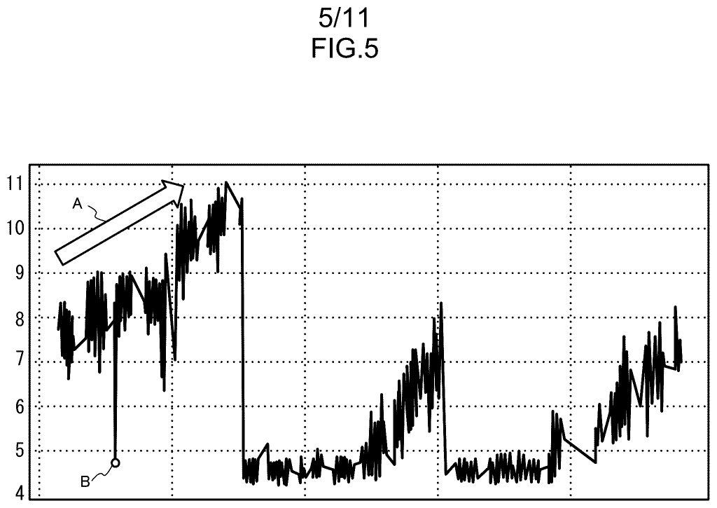

FIG. 5 is a graph illustrating a temporal change in an abnormality degree related to a torque command of the spindle motor when a workpiece is cut by a tool attached to the spindle. In an example of FIG. 5, an abnormality degree of a detected value is calculated after setting the torque command of the spindle motor detected during machining using a new tool as reference data. In addition, coolant is supplied using a center through method to remove chips generated during machining and to cool the tool and the workpiece. In general, tool wear progresses as machining of the workpiece progresses. Therefore, as observed in a part of a white arrow A of FIG. 5, the abnormality degree calculated from the torque command of the spindle motor increases as the machining progresses. In addition, when coolant jetting stops intermittently during machining, a phenomenon occurs in that the abnormality degree calculated from the torque command of the spindle motor abruptly decreases and then returns to an original state, as observed in a part of a white circle B. When the diagnostic device 1 according to this embodiment performs diagnosis based on such data, for example, a predetermined threshold AThs is set for the abnormality degree calculated from the torque command of the spindle motor, and at a time point when the abnormality degree exceeds the threshold, it is possible to diagnose that tool wear has reached a limit. Meanwhile, a predetermined threshold VThs is set for a change rate of the abnormality degree calculated from the torque command of the spindle motor, and at a time point when the change rate of abnormality degree exceeds the threshold, it is detected that an abnormality has occurred in the center through coolant.

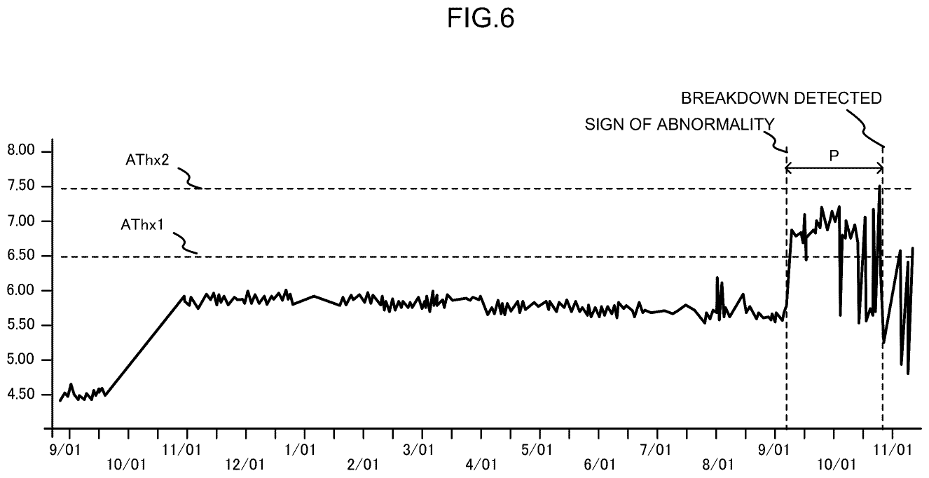

FIG. 6 is a graph illustrating a temporal change in an abnormality degree related to a torque command of the feed axis motor when the workpiece is cut by the tool attached to the spindle. In an example of FIG. 6, an abnormality degree of a detected value is calculated after setting a torque command detected when a new feed axis motor is introduced as reference data. Further, AThx1 and AThx2 are set as abnormality degree thresholds of the torque command of the feed axis motor. In the example illustrated in FIG. 6, for about two months (period P) until the feed axis motor breaks down, the abnormality degree increases and then the abnormality degree repeats increase and decrease, eventually leading to the breakdown. When the abnormality degree threshold AThx1 is set by focusing only on the abnormality degree, the abnormality degree calculated in the period P until the subsequent breakdown crosses over the abnormality degree threshold AThx1 many times, and thus a lot of unnecessary notifications are wastefully generated. On the other hand, when a predetermined change rate threshold is set for a change rate of the abnormality degree, and an abnormality is detected based on the change rate, a notification can be output only when a large change occurs in the abnormality degree. As described above, it is common to finally lead to a breakdown after minor abnormalities repeatedly occur intermittently. In such a case, notifications can be issued at an appropriate frequency by issuing a notification at a change point when abnormality degrees over a long period time, rather than an abnormality degree, are observed.

The diagnostic device 1 according to this embodiment having the above configuration focuses not only on the abnormality degree but also on the change rate of the abnormality degree, and diagnoses a state related to the industrial machine 4 using both of the abnormality degree and the change rate. By adopting this configuration, it is possible to flexibly detect an abnormality for both an abnormality mode in which the abnormality degree gradually changes and an abnormality mode in which the abnormality degree abruptly changes.

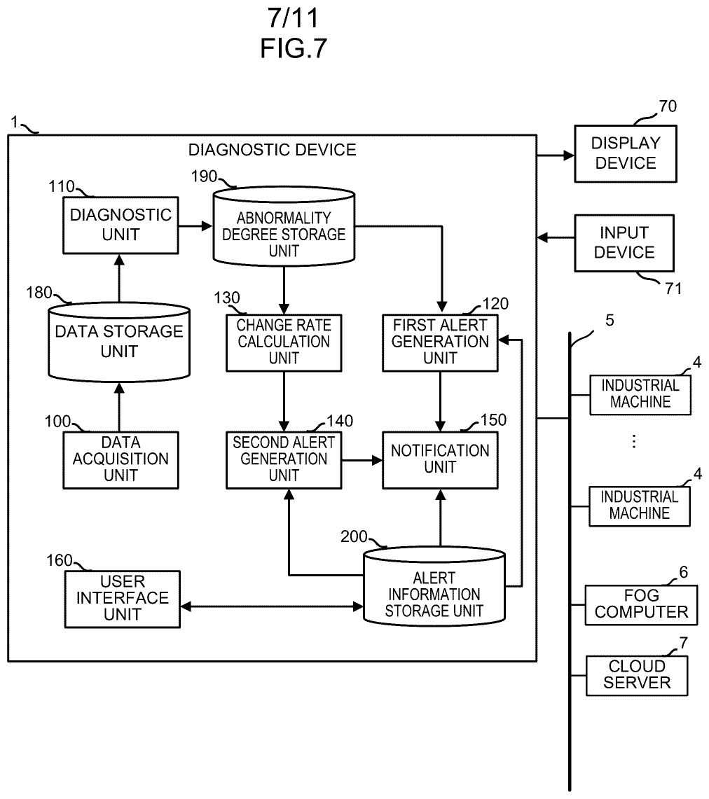

FIG. 7 illustrates functions of a diagnostic device 1 according to a second embodiment of the invention as a schematic block diagram. Each function of the diagnostic device 1 according to this embodiment is realized by the CPU 11 included in the diagnostic device 1 illustrated in FIG. 1 executing a system program and controlling an operation of each unit of the diagnostic device 1.

The diagnostic device 1 of this embodiment is obtained by adding a user interface unit 160 for setting conditions to the diagnostic device 1 of the first embodiment. The user interface unit 160 displays, on the display device 70, a screen for editing the abnormality degree threshold table and the change rate threshold table stored in the alert information storage unit. The user can set the threshold of the abnormality degree and the threshold of the change rate while referring to the tables displayed on the screen.

The diagnostic device 1 according to this embodiment having the above configuration can freely set the abnormality degree threshold and the change rate threshold for each piece of data. Depending on the installation environment or equipment of the industrial machine 4, a value of the abnormality degree or the change rate that needs to be determined as an abnormality may change. In such a case, the user can set an appropriate threshold depending on the installation environment or equipment of the industrial machine 4.

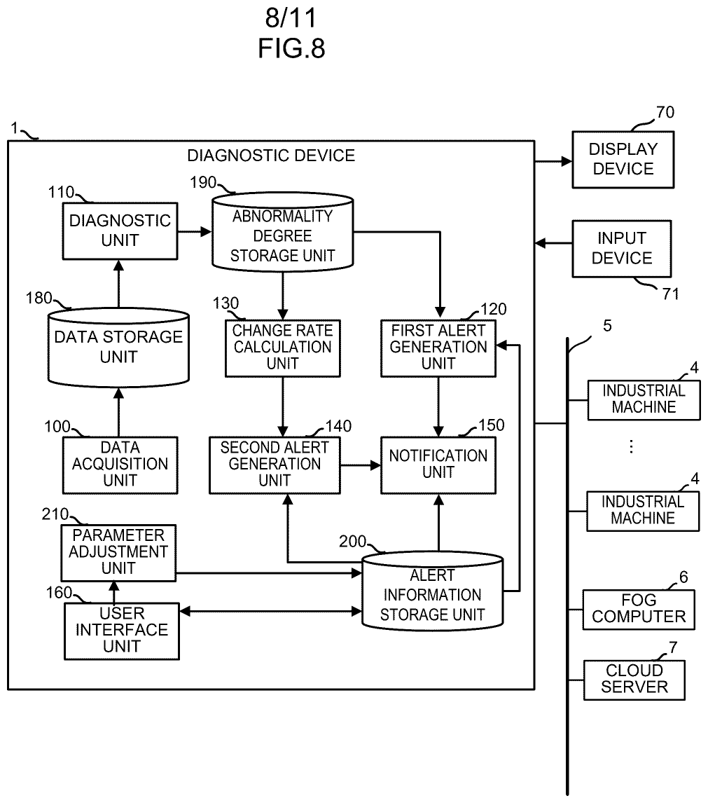

As one modification of the diagnostic device 1 according to the second embodiment, instead of directly setting the abnormality degree threshold and the change rate threshold, it is conceivable to adopt a configuration in which the abnormality degree threshold or the change rate threshold can be indirectly set based on a value of an abnormality degree detected in the past, a notification frequency, etc. FIG. 8 illustrates functions of a diagnostic device 1 according to this modification as a schematic block diagram. The diagnostic device 1 of this modification is obtained by adding a parameter adjustment unit 210 that adjusts each threshold based on input of the user to the diagnostic device 1 according to the second embodiment.

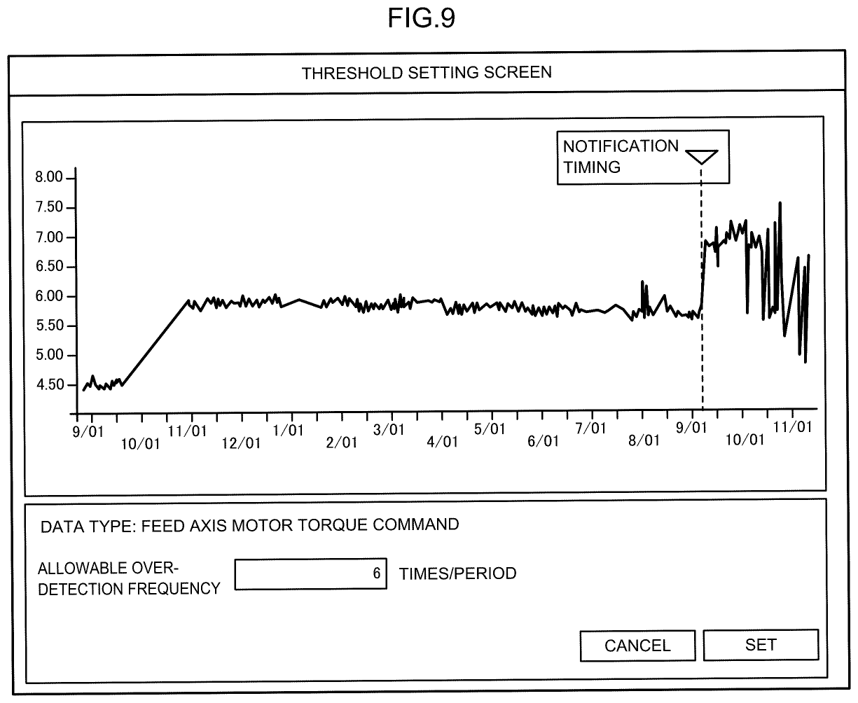

A user interface unit 160 according to this modification displays time-series data of abnormality degrees detected in the past on the display device 70. Then, the timing of a notification input by the user is received while referring to the displayed time-series data. FIG. 9 is an example of a threshold setting screen displayed by the user interface unit 160 according to this modification. As illustrated in FIG. 9, the user interface unit 160 displays, as time-series data, abnormality degrees detected in the past related to designated data type. While viewing this display, the user can designate timing when a notification is issued using a pointing device, etc. In addition, it is possible to designate another value such as an allowable over-detection frequency using a keyboard, etc.

The parameter adjustment unit 210 calculates an appropriate abnormality degree threshold and change rate threshold based on the notification timing, the allowable over-detection frequency, and the time-series data, which is the displayed abnormality degrees, received by the user interface unit 160. Then, the calculated abnormality degree threshold and change rate threshold are set in the alert information storage unit 200. The parameter adjustment unit 210 may be configured to calculate the abnormality degree threshold and the change rate threshold, for example, by solving an optimization problem. In this case, the abnormality degree threshold and the change rate threshold as a parameter set, the number m of data samples used to calculate the average value p and the standard deviation 6 of the abnormality degree in Equation 1, and a parameter used to calculate a statistic by the change rate calculation unit 130 are used. Then, when a value of a predetermined parameter set is applied, timing at which a notification occurs in time-series data, which is abnormality degrees, detected in the past is calculated. Then, a degree to which the calculated notification timing matches the timing designated by the user, information indicating whether a frequency at which notifications occur falls within the allowable over-detection frequency, etc. is set as an evaluation value, and a value of a parameter set maximizing the evaluation value is searched for. Then, the value of the parameter set maximizing the evaluation value is set as the appropriate abnormality degree threshold and change rate threshold, and other parameter values.

By using the diagnostic device 1 according to this modification, the user can set the abnormality degree threshold and the change rate threshold by designating a value easily detected intuitively.

Even though the embodiments of the invention have been described above, the invention is not limited only to the above-described embodiments, and can be implemented in various forms by making appropriate changes.

For example, in the embodiments described above, the first alert generation unit 120 and the second alert generation unit 140 are configured to determine to notify an alert based on the abnormality degree and the change rate, respectively. However, a configuration may be provided to make a determination based on values of both the abnormality degree and the change rate.

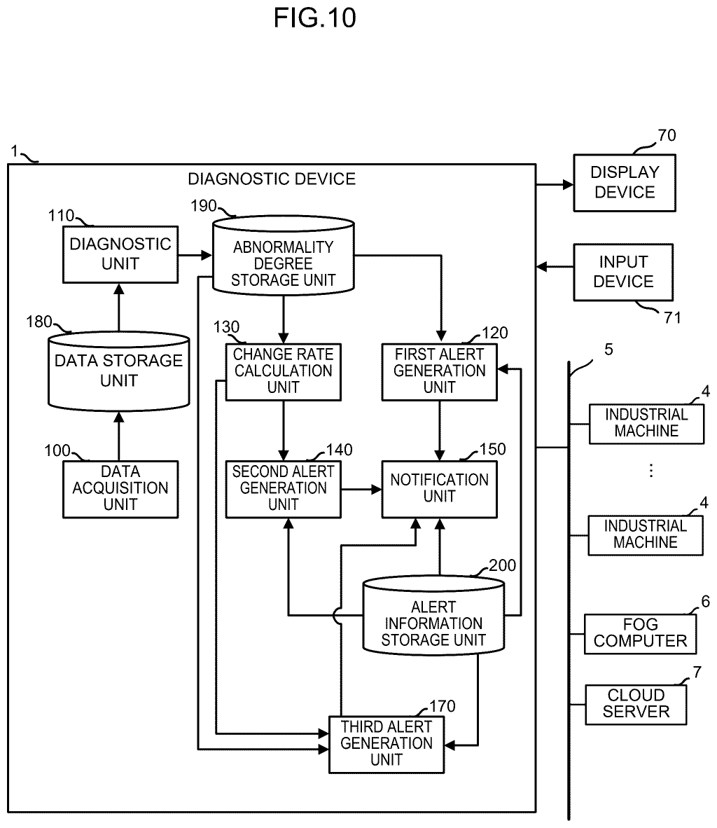

FIG. 10 illustrates functions of a diagnostic device 1 according to another embodiment as a schematic block diagram. The diagnostic device 1 according to this embodiment further includes a third alert generation unit 170 in addition to the first alert generation unit 120 and the second alert generation unit 140.

With regard to the data acquisition unit 100, the diagnostic unit 110, the first alert generation unit 120, the change rate calculation unit 130, the second alert generation unit 140, and the notification unit 150 included in the diagnostic device 1 according to this embodiment, functions are similar to the respective functions of the diagnostic device 1 according to the first embodiment.

The third alert generation unit 170 according to this embodiment determines whether or not a predetermined notification is necessary based on an abnormality degree related to predetermined data calculated by the diagnostic unit 110 and a change rate of an abnormality degree related to predetermined data calculated by the change rate calculation unit 130. For example, the third alert generation unit 170 may calculate a predetermined conditional expression using the abnormality degree and the change rate as parameters, and determine that a predetermined notification is necessary when the predetermined conditional expression is satisfied. The predetermined notification may be, for example, a warning notification related to the predetermined data.

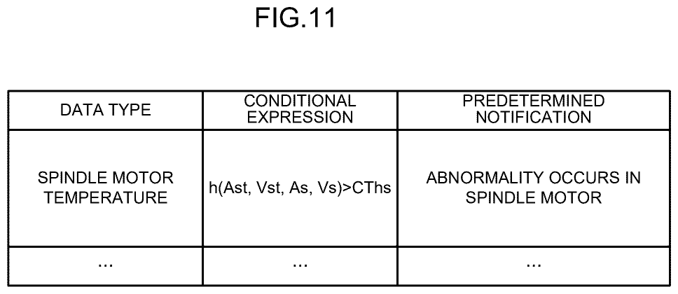

The predetermined conditional expression may be determined in advance for each type of data. Further, a plurality of predetermined conditional expressions may be associated with one data type. Furthermore, a threshold may be dynamically changed based on a predetermined conditional expression. For example, a relationship between the data type and the predetermined conditional expression may be stored in the alert information storage unit 200 in advance in association with each other. FIG. 11 illustrates an example in which the relationship between the data type and the predetermined conditional expression is determined using a conditional expression table. As illustrated in FIG. 11, the conditional expression table stores at least one or more pieces of conditional expression data that associate a conditional expression with a predetermined notification for a data type. In the example of FIG. 11, for example, for data of a spindle motor temperature, a conditional expression satisfied when a result of calculation using a function h having an abnormality degree Ast of the spindle motor temperature, a change rate Vst of the spindle motor temperature, an abnormality degree As of a torque command of a spindle motor, and a change rate Vs of the torque command of the spindle motor as arguments exceeds a threshold CThs is defined, and a notification “an abnormality occurs in the spindle motor” is associated therewith. The third alert generation unit 170 specifies a predetermined conditional expression according to each type of data with reference to this table. Then, whether or not a predetermined conditional expression is satisfied is evaluated using an abnormality degree, a change rate, etc. of each piece of data, and necessity of a predetermined notification is determined.

The diagnostic device 1 according to another embodiment having the above configuration diagnoses a state related to the industrial machine 4 by determining a complex conditional expression using an abnormality degree and a change rate of the abnormality degree. By adopting this configuration, it becomes possible to flexibly detect an abnormality mode that can be detected under a more complicated condition.

### EXPLANATIONS OF LETTERS OR NUMERALS

1 DIAGNOSTIC DEVICE
4 INDUSTRIAL MACHINE
5 NETWORK
6 FOG COMPUTER
7 CLOUD SERVER
11 CPU
12 ROM
13 RAM
14 NONVOLATILE MEMORY
15, 18, 19, 20 INTERFACE
22 BUS
70 DISPLAY DEVICE
71 INPUT DEVICE
72 EXTERNAL DEVICE
100 DATA ACQUISITION UNIT
110 DIAGNOSTIC UNIT
120 FIRST ALERT GENERATION UNIT
130 CHANGE RATE CALCULATION UNIT
140 SECOND ALERT GENERATION UNIT
150 NOTIFICATION UNIT
160 USER INTERFACE UNIT
170 THIRD ALERT GENERATION UNIT
180 DATA STORAGE UNIT
190 ABNORMALITY DEGREE STORAGE UNIT
200 ALERT INFORMATION STORAGE UNIT
210 PARAMETER ADJUSTMENT UNIT

1. A diagnostic device configured to diagnose a predetermined state related to an industrial machine, the diagnostic device comprising:
a data acquisition unit configured to acquire data indicating a predetermined state related to the industrial machine;
a diagnostic unit configured to calculate an abnormality degree of the state for the data acquired by the data acquisition unit based on a deviation degree from a distribution of the data acquired in a reference state;
a change rate calculation unit configured to calculate a change degree of the abnormality degree as a change rate;
a first alert generation unit configured to compare the abnormality degree with an abnormality degree threshold and determine whether or not a predetermined notification is necessary;
a second alert generation unit configured to compare the change rate with a change rate threshold and determine whether or not the predetermined notification is necessary; and
a notification unit configured to output the predetermined notification based on results of determinations by the first alert generation unit and the second alert generation unit.

2. The diagnostic device according to claim 1, wherein a statistic of abnormality degrees at certain time intervals is calculated, and the calculated statistic is treated as the abnormality degree.

3. The diagnostic device according to claim 1, wherein the change rate calculation unit calculates the change rate based on a difference from an abnormality degree calculated before one time.

4. The diagnostic device according to claim 1, wherein the change rate calculation unit calculates the change rate based on a statistic with at least one most recently calculated abnormality degree.

5. The diagnostic device according to claim 1, further comprising a user interface unit for setting the abnormality degree threshold and the change rate threshold.

6. The diagnostic device according to claim 5, wherein:
the user interface unit displays the abnormality degree calculated by the diagnostic unit in time series, and receives input of timing of notification from display content and an allowable over-detection frequency,
wherein the diagnostic device further comprises a parameter adjustment unit configured to automatically adjust the abnormality degree threshold, the change rate threshold, and other parameters based on the received input of the notification timing and the allowable over-detection frequency, and the abnormality degree.

7. The diagnostic device according to claim 1, wherein whether or not a user has confirmed the predetermined notification is managed for each predetermined notification.

8. A computer-readable recording medium recording a program causing a computer to execute processing for diagnosing a predetermined state related to an industrial machine, the computer-readable recording medium recording the program causing the computer to operate as:
a data acquisition unit configured to acquire data indicating a predetermined state related to the industrial machine;
a diagnostic unit configured to calculate an abnormality degree of the state for the data acquired by the data acquisition unit based on a deviation degree from a distribution of the data acquired in a reference state;
a change rate calculation unit configured to calculate a change degree of the abnormality degree as a change rate;
a first alert generation unit configured to compare the abnormality degree with an abnormality degree threshold and determine whether or not a predetermined notification is necessary;
a second alert generation unit configured to compare the change rate with a change rate threshold and determine whether or not the predetermined notification is necessary; and
a notification unit configured to output the predetermined notification based on results of determinations by the first alert generation unit and the second alert generation unit.
